(19) United States
(12) Patent Application Publication
(10) Pub. No.: US 2009/0115745 A1
(43) Pub. Date: May 7, 2009

(54) STYLUS, HANDHELD ELECTRONIC DEVICE, AND METHOD FOR OPERATING THE SAME

(75) Inventors: I-Cheng Chuang, Tao Yuan (TW); Yu-Jing Liao, Tao Yuan (TW); Ying-Yen Cheng, Tao Yuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HIGH TECH COMPUTER, CORP., Taoyuan County (TW)

(21) Appl. No.: 12/129,618

(22) Filed: May 29, 2008

(30) Foreign Application Priority Data
Nov. 2, 2007 (TW) 96141565

(51) Int. Cl. G06F 3/033; G06K 11/06

(52) U.S. Cl. 345/179; 178/19.03

(57) ABSTRACT

A handheld electronic device comprising a main body, a stylus and a non-contact sensor is provided. The main body has a containing slot, and the stylus having a sensing region is suitable for being inserted into the containing slot. The non-contact sensor is disposed beside the containing slot. The non-contact sensor outputs a sensing signal for identifying the position of the stylus when the stylus moves in the containing slot and the sensing region of the stylus passes the non-contact sensor. By detecting the position of the stylus in a non-contact manner, the reliability and the lifetime of the handheld electronic device are improved, and a higher sensing precision is also provided.

### CROSS-REFERENCE TO RELATED APPLICATION

This application claims the priority benefit of Taiwan application serial no. 96141565, filed on Nov. 2, 2007. The entirety of the above-mentioned patent application is hereby incorporated by reference herein and made a part of specification.

### BACKGROUND OF THE INVENTION

1. Field of the Invention

The present invention relates to a handheld electronic device, and in particular, to a handheld electronic device capable of identifying the position of a stylus by using a non-contact method.

2. Description of Related Art

A handheld electronic device is an electronic device which can be held and operated in a user's hand and is portable because of small size and light weight. Common handheld electronic devices in the current market include, for example, a mobile phone, a multimedia player, a personal digital assistant (PDA), a pocket PC, a handheld game console, and a handheld global positioning system (GPS).

Some of the handheld electronic devices (e.g. PDA) in the current market are equipped with touch screens which provide input interfaces and display interfaces at the same time. In order to be used with the touch screens, the handheld electronic device is equipped with a stylus, and thereby the user can touch items displayed on the screen to select them or input words by using the stylus, so as to perform the functions built in the handheld electronic device.

Usually, a traditional handheld electronic device has a containing slot disposed inside. When the user does not use the stylus, the stylus can be inserted into the containing slot of the main body for the convenience of storing and carrying. Moreover, a switch is usually disposed on a main body of the handheld electronic device. Therefore, when the user wants to use the handheld electronic device, the switch must be pressed manually in order to control the electronic device to switch from a sleeping status to a working status, namely, the screen of the handheld electronic device is switched on. At this moment, if the user wants to use the stylus, the user call pull out the stylus from the containing slot. When the user does not use the handheld electronic device, the users need to press the switch manually in order to control the electronic device to switch from the working status to the sleeping status, namely, the screen of the handheld electronic device is switched off. Thereafter, the user also inserts the stylus back into the containing slot.

The user needs to press the switch manually no matter when using the handheld electronic device or when deciding not to use the handheld electronic device, which leads to inconvenience in use. Moreover, due to the mechanical design of the switch, the switch can be worn down after a long time of use, and thereby reducing the reliability and the service life of the products.

### SUMMARY OF THE INVENTION

The present invention relates to a handheld electronic device capable of identifying a position of a stylus by means of a non-contact method, so that users can control operation of the handheld electronic device easily and conveniently.

The present invention relates to a handheld electronic device identifying a position of a stylus by means of a non-contact method for performing a predetermined function, and thereby the convenience in use is enhanced.

The present invention also relates to a stylus applying in the aforementioned handheld electronic device and a method for operating the handheld electronic device.

In order to describe the present invention more specifically, a handheld electronic device mainly including a main body, a stylus and a non-contact sensor is set forth hereinafter. The main body has a containing slot. The stylus has a sensing region and is suitable for being inserted into the containing slot. The non-contact sensor is disposed beside the containing slot. The non-contact sensor outputs a sensing signal when the stylus moves in the containing slot and the sensing region of the stylus passes the non-contact sensor. The main body is suitable for accepting the sensing signal and performing a predetermined function according to the sensing signal.

Furthermore, a stylus, suitable for being inserted into a containing slot of a main body of a handheld electronic device is provided. The handheld electronic device has a non-contact sensor disposed beside the containing slot. The stylus has a sensing region and is suitable for being inserted into the containing slot, the non-contact sensor outputs a sensing signal when the stylus moves in the containing slot and the sensing region of the stylus passes the non-contact sensor. The main body is suitable for accepting the sensing signal and performs a predetermined function according to the sensing signal.

A method for operating the handheld electronic device is also provided. The method comprises taking the stylus out from the containing slot so as to enable the main body to performing a predetermined function according to the sensing signal.

In light of the above, according to the present invention, the position of the stylus in the containing slot of the main body is identified by using the non-contact sensor to detect the sensing region of the stylus. On the other hand, according to the present invention, a predetermined function can be performed by the main body of the handheld electronic apparatus according to a position of the stylus, so that the convenience in use is enhanced.

In order to make the above and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 and 2 respectively are a schematic view illustrating a handheld electronic device with a stylus thereof stored in a main body and a schematic view illustrating a handheld electronic device with a stylus pulled out from the main body according to one embodiment of the present invention.

FIGS. 3A and 3B are schematic views illustrating relative movements between a non-contact sensor and a sensing region of the stylus.

FIG. 4 is a partial perspective view schematically illustrating the stylus according to one embodiment of the present invention.

### DESCRIPTION OF EMBODIMENTS

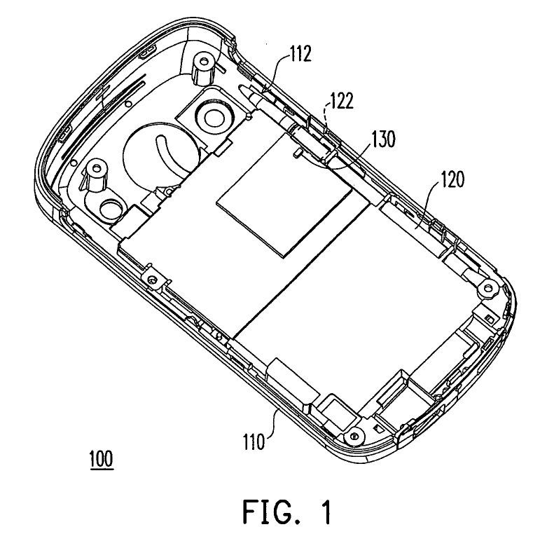

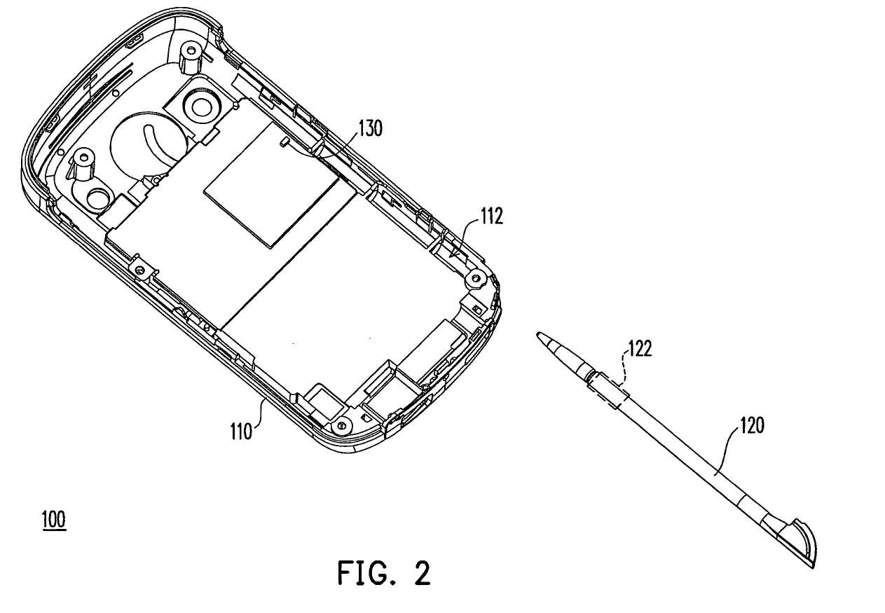

FIGS. 1 and 2 respectively are a schematic view illustrating a handheld electronic device with a stylus thereof stored in a main body and a schematic view illustrating a handheld electronic device with a stylus pulled out from the main body according to one embodiment of the present invention. As shown in FIGS. 1 and 2, the handheld electronic device 100 mainly includes the main body 110, the stylus 120 and other elements. The main body 110 has a containing slot 112 for containing the stylus 120.

According to the present embodiment, in order to identify the position of the stylus 120 by a non-contact method, a non-contact sensor 130 is disposed beside the containing slot 112 of the main body 110, and the stylus 120 has a sensing region 122 corresponding to the non-contact sensor 130. A position of the sensing region 122 can be designed to enable the sensing region 122 to pass the non-contact sensor 130 after the stylus 120 is inserted into the containing slot 112, and thereby the non-contact sensor 130 can detect the sensing region 122 and output a sensing signal when the sensing region 122 passes by. Moreover, the main body 110 is suitable for accepting the sensing signal and performing a predetermined function according to the sensing signal.

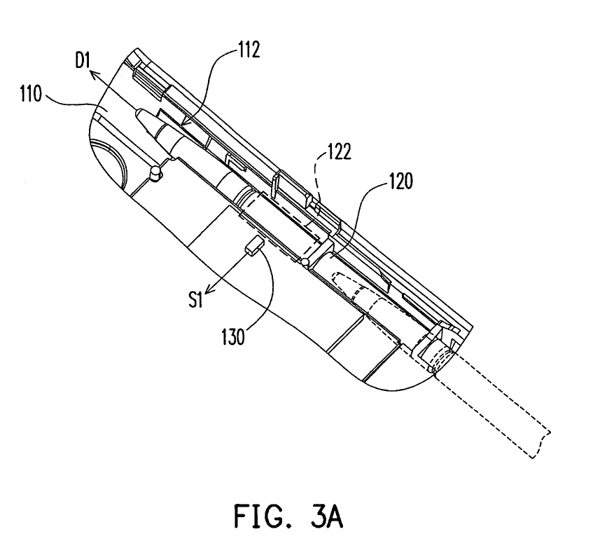

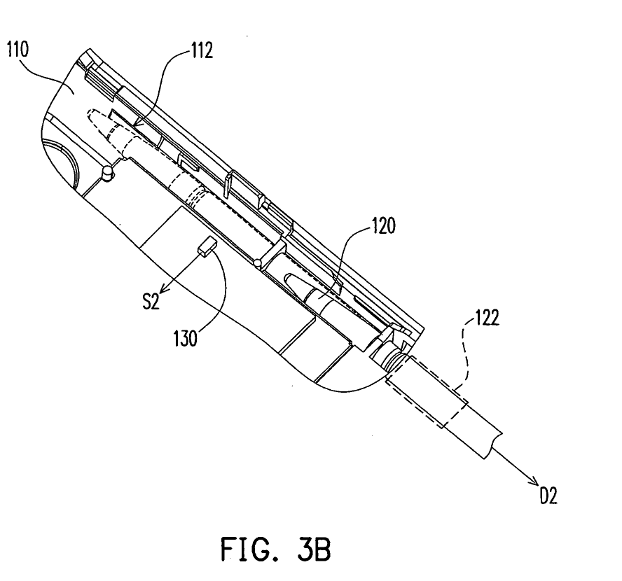

More specifically, according to the present embodiment, the positions of the stylus 120 and the main body 110 of the handheld electronic device 100 can be identified by the sensing signal. FIGS. 3A and 3B are schematic views illustrating relative movements between the non-contact sensor 130 and the sensing region 122 of the stylus 120. As shown in FIG. 3A, when users do not use the stylus 120 and insert the stylus 120 into the containing slot 112 of the main body 110, the sensing region 122 of the stylus 120 passes the non-contact sensor 130 along a direction D1, and thereby a sensing signal S1 is generated. As shown in FIG. 3B, when the users want to use the stylus 120 and pull out the stylus 120 from the containing slot 112 of the main body 110, the sensing region 122 of the stylus 120 passes the non-contact sensor 130 along an opposite direction D2, and thereby another sensing signal S2 is generated. In other words, different sensing signals are generated when the stylus 120 passes the non-contact sensor 130 along different directions. Thereby, a relative position of the stylus 120 to the main body 110 can be identified based on different sensing signals.

It should be noted that according to the present embodiment, the non-contact sensor 130 can identify the position of the stylus 120 by using a non-contact magnetic sensing method and no direct contacts are required between the stylus 120 and the non-contact sensor 130. Furthermore, because the non-contact sensor 130 can detect the stylus 120 within a specific distance from the non-contact sensor 130, the alignment tolerance between the main body 110 and the stylus 120 can be larger.

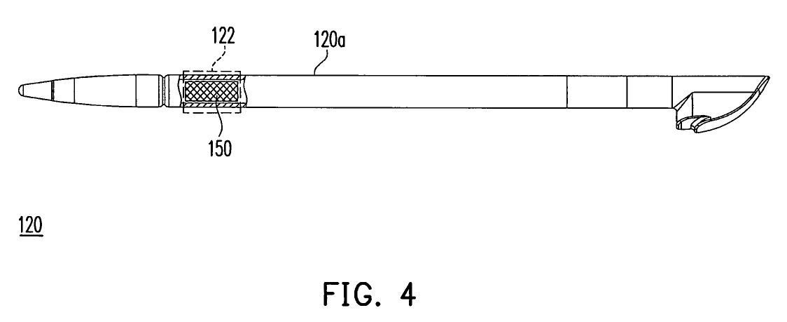

In practice, the afore-mentioned non-contact sensing method according to the present embodiment can be performed by using a magnetic sensing method. In other words, the non-contact sensor 130 can be, for example, a magneto-resistive sensor (MR sensor) while the sensing region 122 can be, for example, a magnetic region. According to the present embodiment, a magnetic element can be disposed in a proper position inside the stylus 120 for forming the sensing region 122 of the stylus 120. FIG. 4 is a partial perspective view of the stylus 120, wherein the stylus 120 mainly includes a hollow body 120a, and a magnetic element 150 is disposed in the hollow body 120a for forming the aforementioned sensing region 122. The magnetic element 150 has an S pole and an N pole, and the S pole and the N pole are arranged in a direction substantially parallel to a long direction of the stylus 120. Therefore, the non-contact sensor 130 can output different sensing signals when the stylus 120 is stored in the main body 110 or pulled out from the main body 110. According to the present embodiment, the magnetic element 150 is, for example, a common permanent magnet or other elements having the same property.

According to other embodiments of the present invention, other non-contact sensing methods can be utilized instead of the aforementioned magnetic non-contact sensing method. For example, the non-contact sensor can be a photo sensitive sensor. The photo sensitive sensor can identify the position of the stylus through the variations of the external light. According to different types of the photo sensitive sensor, the sensing region of the stylus can be a transparent region, an opaque region or a reflective region.

Furthermore, in order to increase the convenience of using the handheld electronic device for the users, the present invention can further incorporate the aforementioned sensing method for identifying the position of the stylus with a control of operation, so that the handheld electronic device can automatically perform a predetermined function according to the position of the stylus. The position of the stylus usually varies with the usage status of the handheld electronic device. For example, the predetermined function can control a display screen to switch on and switch off. Moreover, the predetermined function can execute or close a certain application program. For example, when replying to a message, a handwriting tablet or a keyboard can automatically be switched off as the stylus is inserted back into the containing slot. When executing a built-in game, the game can be automatically closed as the stylus is inserted back into the containing slot. In addition, the above-mentioned predetermined function can be an alert sound provided by the main body. Moreover, the display screen of the main body is locked, and the stylus is inserted into the containing slot. The presetting function can be unlocking the display screen when the stylus is taken out from the containing slot.

More specifically, when users want to use the touch control function provided by the handheld electronic device, they usually pull out the stylus from the main body first. The aforementioned habit can be utilized to design the predetermined function of switching on and switching off the display screen, for example. Referring to FIG. 3B, the non-contact sensor 130 outputs the sensing signal S2 at this moment, the main body 110 can receives the sensing signal S2 to switch on the display screen of the main body 110 according to the sensing signal S2. In other words, the users can directly watch and use the display screen right after pulling out the stylus 120.

Moreover, referring to FIG. 3A, when the users do not use the handheld electronic device, the stylus 120 is inserted back into the main body 110. At this moment, the non-contact sensor 130 outputs the sensing signal S1 accordingly, and the main body 110 can receive the sensing signal S1 to switched off the display screen automatically.

In summary, according to the present invention, a non-contact sensing method is utilized to detect the sensing region of the stylus for controlling the display screen to switch on and switch off. Therefore, compared with a prior art, the handheld electronic device of the present invention provides higher reliability and longer lifetime. Furthermore, by using the method of sensing the position of the stylus to perform a predetermined function, the convenience of using the electronic handheld device can be enhanced.

Although the present invention has been described with reference to the above embodiments, it will be apparent to one of the ordinary skill in the art that modifications to the described embodiments may be made without departing from the spirit of the invention. Accordingly, the scope of the invention will be defined by the attached claims not by the above detailed description.

What is claimed is:

1. A handheld electronic device, comprising:
a main body having a containing slot;
a stylus having a sensing region, the stylus being suitable for being inserted into the containing slot; and
a non-contact sensor disposed beside the containing slot, wherein the non-contact sensor outputs a sensing signal when the stylus moves in the containing slot and the sensing region of the stylus passes the non-contact sensor, and the main body is suitable for accepting the sensing signal and performing a predetermined function according to the sensing signal.

2. The handheld electronic device according to claim 1, wherein the non-contact sensor is a magneto-resistive sensor (MR sensor), and the sensing region is a magnetic region.

3. The handheld electronic device according to claim 2, wherein the stylus comprises:
a hollow body; and
a magnetic element disposed in the hollow body.

4. The handheld electronic device according to claim 3, wherein the magnetic element has an S pole and an N pole, and the S pole and the N pole are arranged in a direction substantially parallel to a long direction of the stylus.

5. The handheld electronic device according to claim 3, wherein the magnetic element is a permanent magnet.

6. The handheld electronic device according to claim 1, wherein the non-contact sensor is a photo sensitive sensor, and the sensing region comprises a transparent region, an opaque region and a reflective region.

7. The handheld electronic device according to claim 1, wherein the main body has a display screen and the predetermined function comprises controlling the display screen to switch on and switch off.

8. A stylus, suitable for being inserted into a containing slot of a main body of a handheld electronic device, wherein the handheld electronic device has a non-contact sensor disposed beside the containing slot, the stylus has a sensing region, the stylus is suitable for being inserted into the containing slot, the non-contact sensor outputs a sensing signal when the stylus moves in the containing slot and the sensing region of the stylus passes the non-contact sensor, and the main body is suitable for accepting the sensing signal and performing a predetermined function according to the sensing signal.

9. The stylus according to claim 8, wherein the non-contact sensor is a magneto-resistive sensor (MR sensor), and the sensing region is a magnetic region.

10. The stylus according to claim 9, comprising:
a hollow body; and
a magnetic element disposed in the hollow body.

11. The stylus according to claim 10, wherein the magnetic element has an S pole and an N pole, and the S pole and the N pole are arranged in a direction substantially parallel to a long direction of the stylus.

12. The stylus according to claim 10, wherein the magnetic element is a permanent magnet.

13. The stylus according to claim 8, wherein the non-contact sensor is a photo sensitive sensor, and the sensing region comprises a transparent region, an opaque region and a reflective region.

14. The stylus according to claim 8, wherein the main body has a display screen and the predetermined function comprises controlling the display screen to switch on and switch off.

15. A method for operating the handheld electronic device of claim 1, wherein the stylus is inserted into the containing slot, the method comprising:
taking the stylus out from the containing slot so as to enable the main body to performing a predetermined function according to the sensing signal.

16. The method according to claim 15, wherein the main body has a display screen and the predetermined function comprises controlling the display screen to switch on and switch off.

17. The method according to claim 15, wherein the predetermined function comprises quitting or executing an application program.

18. The method according to claim 15, wherein the predetermined function comprises generating an alert sound.

19. The method according to claim 15, wherein the presetting function comprises unlocking the display screen of the main body.
